(19) United States
(12) Patent Application Publication
(10) Pub. No.: US 2022/0078283 A1
(43) Pub. Date: Mar. 10, 2022

(54) HAPTIC ALERTS CORRESPONDING TO CONTACT CENTER EVENTS

(71) Applicant: Avaya Management L.P., Santa Clara, CA (US)

(72) Inventors: Pushkar Yashavant Deole, Pune (IN); Sandesh Chopdekar, Pune (IN); Navin Daga, Silapathar (IN)

(21) Appl. No.: 17/016,885

(22) Filed: Sep. 10, 2020

(51) Int. Cl. H04M 3/51; G08B 6/00; G06Q 10/06; G05B 19/4155

(52) U.S. Cl. CPC H04M 3/5175; G08B 6/00; G05B 2219/40619; G06Q 10/0639; G05B 19/4155; H04M 3/5183

(57) ABSTRACT

The technology disclosed herein enables presentation of haptic alerts to a user (e.g., agent, supervisor, or other human resource of a contact center) regarding events of a contact center. In a particular embodiment, a method provides identifying a first event at a user system operated by the user. The first event is associated with operation of a contact center staffed with a plurality of agents. The method further provides determining that a first haptic alert corresponds to the first event and directing a haptic device in contact with the user's body to generate the first haptic alert for the user.

### TECHNICAL BACKGROUND

When participating in the operation of a contact center, a user (e.g., agent, supervisor, or other human resource) is aided by notifications alerting them in real-time about occurrences that are pertinent to the user's duties. For example, a supervisor may be notified when a certain metric (e.g., average hold time) crosses a threshold, so that the supervisor can take action (e.g., reassign agents) to bring the metric back from across the threshold. Visual notifications may be presented on the user's terminal, although, visual notifications are not always noticed by the user, especially given the amount of content that can be displayed on a modern computing screen. Likewise, should the user be visually impaired, visual notifications may be completely ineffective. While audible notifications can overcome some drawbacks of visual notifications, audible notifications can be missed if the user is participating in a voice conversation (e.g., speaking with a caller to the contact center) and an audible notification during a conversation may distract the user from the conversation itself. Additionally, braille-type notifications convert information to braille for the visually impaired but have their own drawbacks. For instance, a metric may be color coded to visually represent how well the metric conforms to a policy. In an example, as the metric gets closer to a violating a policy, a displayed color corresponding to the metric may change from green to yellow). Such color changes are difficult, if not impossible, to represent effectively using braille.

### SUMMARY

The technology disclosed herein enables presentation of haptic alerts to a user regarding events of a contact center. In a particular embodiment, a method provides identifying a first event at a user system operated by the user. The first event is associated with operation of a contact center staffed with a plurality of agents. The method further provides determining that a first haptic alert corresponds to the first event and directing a haptic device in contact with the user's body to generate the first haptic alert for the user.

In some embodiments, the method provides identifying a second event at the user system, determining that a second haptic alert, which is different than the first haptic alert, corresponds to the second event, and directing the haptic device to generate the second haptic alert for the user.

In some embodiments, the first haptic alert comprises a vibration pattern.

In some embodiments, the first haptic alert comprises an application of pressure applied to one or more defined areas on the user's body.

In some embodiments, directing the haptic device includes transferring, to the haptic device, an instruction for the haptic device to generate the first haptic alert. The haptic device includes circuitry that processes the instruction and controls one or more haptic actuators of the haptic device. In those embodiments, the instruction may be transferred over a wireless link between the user system and the haptic device, and the haptic device may include a power supply to power the one or more actuators.

In some embodiments, determining that the first haptic alert corresponds to the first event includes, in the user system, executing a haptic-alert application that monitors for events from an application associated with the first event.

In some embodiments, the user is a supervisor of the plurality of agents and wherein the first event relates to a metric about performance of the agents.

In some embodiments, the haptic device is worn by the user.

In some embodiments, the user sits on the haptic device.

In another embodiment, an apparatus includes one or more computer readable storage media and a processing system operatively coupled with the one or more computer readable storage media. Program instructions stored on the one or more computer readable storage media, when read and executed by the processing system, direct the processing system to identify a first event at a user system operated by the user. The first event is associated with operation of a contact center staffed with a plurality of agents. The program instructions further direct the processing system to determine that a first haptic alert corresponds to the first event and direct a haptic device in contact with the user's body to generate the first haptic alert for the user.

### BRIEF DESCRIPTION OF THE DRAWINGS

FIG. 1 illustrates an implementation for providing haptic alerts corresponding to contact center events.

FIG. 2 illustrates an operational scenario that provides haptic alerts corresponding to contact center events.

FIG. 3 illustrates another operational scenario that provides haptic alerts corresponding to contact center events.

FIG. 4 illustrates an implementation for providing haptic alerts corresponding to contact center events.

FIG. 5 illustrates an operational scenario that provides haptic alerts corresponding to contact center events.

FIG. 6 illustrates an implementation for providing haptic alerts corresponding to contact center events.

FIG. 7 illustrates an operation for providing haptic alerts corresponding to contact center events.

FIG. 8 illustrates a computing architecture for providing haptic alerts corresponding to contact center events.

### DETAILED DESCRIPTION

The user systems herein use haptic devices to communicate notifications to their users via each user's sense of touch. A haptic alert from one of the haptic devices may include the device causing pressure on one or more locations of the user's body, vibration(s) on one or more locations of the user's body, pinch(es) on one or more locations of the user's body, or some other type of sensation that the user can feel—including combinations thereof. The haptic alert does not rely on a user's ability to see. Thus, a visually impaired user can still receive the haptic alert and even a non-impaired user does not need to be looking at a display screen (or focusing on a certain portion of the display screen) to receive the haptics notification. Likewise, the haptic alert does not suffer from the drawbacks of presenting an audible notification when the user is having a voice conversation.

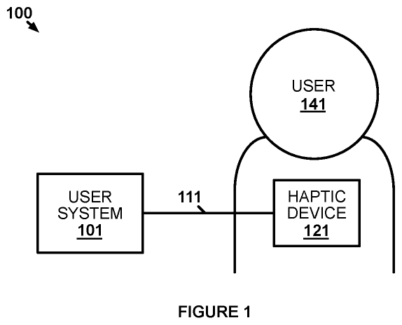

FIG. 1 illustrates implementation 100 for providing haptic alerts corresponding to contact center events. Implementation 100 includes user system 101 and haptic device 121. User system 101 and haptic device 121 communicate over communication link 111. User system 101 may be a telephone, laptop, personal computer, tablet computer, or some other type of user operable computing system. Though shown separately, user system 101 and haptic device 121 may be combined. Communication link 111 may be wired and/or wireless or may be internal links, including system buses, in examples where haptic device 121 is incorporated into user system 101. Communication link 111 is shown as a direct link but may include intervening systems, networks, and/or devices.

In operation, user 141 uses user system 101 in their duties within a contact center. If user 141 is an agent that communicates with callers to the contact center, then user system 101 may be the endpoint for communication sessions over which the agent communicates. User system 101 may execute any number of applications with which user 141 may interact. For example, the applications may include a soft client for communication sessions with the contact center, a ticketing application for service issues, an ordering application for product purchases, a contact center operations application (e.g., for a supervisor to monitor contact center metrics), an email application, or any other type of computer executable application—including combinations thereof. Haptic device 121 is a device that includes one or more solenoids, motors, and/or some other type of actuator that can be felt by the user when activated (e.g., when fed power and/or a control signal). Haptic device 121 may be worn by user 141 or may otherwise in contact with user 141's body such that user 141 can feel activation of the actuators therein. For example, haptic device 121 may be a vest, belt, glove and/or bracelet worn by user 141. In another example, haptic device 121 may also be built into, or otherwise placed on, a chair of user 141. In some cases, haptic device 121 may be multiple components, such as a glove for each hand and a vest, rather than a single component, such as only a vest. It should be understood that haptic device 121 need not directly contact user 141's body to still be considered in contact with user 141's body. Rather, there may be material (e.g., a device housing, clothing, and/or upholstery) between user 141's body and haptic device 121 while still allowing user 141 to feel the activation of haptic device 121. When an event associated with the operation of the contact center occurs, such as one occurring within one of the applications above, haptic device 121 generates a haptic alert corresponding to the event using one or more actuators therein, which alerts user 141 to the event's occurrence.

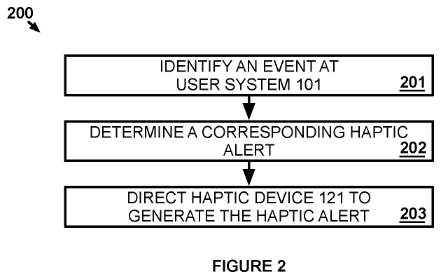

FIG. 2 illustrates operational scenario 200 that provides haptic alerts corresponding to contact center events. In operational scenario 200, user system 101 identifies an event associated with operation of the contact center (201). The event may be an event concerning one or more of the agents, concerning performance metrics of one or more of the agents, concerning performance metrics of the contact center as a whole (e.g., a number of abandoned calls), or some other metric relevant to the operation of the contact center. For events concerning performance metrics, user system 101 may maintain criteria (e.g., threshold values) that indicate to user system 101 when an event occurs. For example, the event may be one or more agent performance metrics satisfying the criteria (e.g., meets a threshold). Notifications about performance metric related events may be beneficial for an agent supervisor or for individual agents themselves, as both can take it upon themselves to make adjustments in response to the notifications. In other examples, another system may maintain the criteria and track the agents' performance metrics and then notify user system 101 when criteria is met, which constitutes user system 101 identifying the event. The event may also be an event concerning an user 141's performance of specific tasks in their duties as a contact center agent. For example, the event may be an incoming communication session, a received message, a reminder for the agent to do something while on a communication session, a notification that something requested by the agent is available, a notification pushed to user system 101 from another system, or any other type of occurrence on user system 101 that user 141 would benefit from being notified about in real-time.

User system 101 also determines a haptic alert that corresponds to the identified event (202). Different events correspond to different haptic alerts, which allows user 141 to differentiate between events based on the feel of the haptic alert. Haptic alerts may be differentiated through the use of different vibration patterns (e.g., different pulse durations, pulse frequencies, intensity, body locations, etc.), different pressure application patterns (e.g., different body locations, amounts of pressure, movements of pressure (e.g., to move clockwise/counterclockwise or “draw” shapes, such as circles or squares, on user 141's body), sizes of pressure area, pressure durations, etc.), or some other manner in which a user would differentiate the feel of different haptic alerts. For example, an incoming call event may correspond to a different vibration pattern than a notification that user 141 is spending too much time on each call, which in turn corresponds to a different vibration pattern than a notification that user 141 is keeping a caller on hold for too long. User system 101 may maintain a data structure that defines the correspondence between haptic alerts and their respective events. In some examples, the data structure may be stored elsewhere, such as a server system in the contact center, and accessed by user system 101. The data structure may further define the haptic alerts themselves (e.g., the particular vibration/pressure pattern). In some examples, user system 101 may allow user 141 to provide user input defining which haptic alerts correspond to which events. In alternative examples, user system 101 may receive information about the correspondence of haptic alerts and events from some other system, such as a contact center policy system. For instance, user system 101 may receive, from an external system, a message indicating that a particular haptic alert should be presented to user 141 after the external system determined that the haptic alert corresponds to the occurrence of an event.

User system 101 directs haptic device 121 to generate the determined haptic alert for user 141 (203). In some examples, user system 101 may direct haptic device 121 to generate the haptic alert by supplying power, or otherwise causing power to be supplied, to one or more actuators of haptic device 121 over link 111 in a manner that causes the actuators to produce the desired haptic alert. For instance, if the haptic alert is a vibration pattern, then user system 101 may power a vibration motor of haptic device 121 on and off to produce the vibration pattern. In some examples, haptic device 121 may include circuitry that receives and processes control messages from user system 101 to activate one or more actuators in haptic device 121 to generate the haptic alert. In those examples, a control message from user system 101 over communication link 111 may simply identify the haptic alert that should be generated (e.g., by a designation for the haptic alert) or the control message may define the haptic alert that should be generated (e.g., the particular vibration/pressure pattern). In the former case, circuitry in haptic device 121 stores the particular vibration/pressure pattern that corresponds to the haptic alerts that may be identified by user system 101.

Advantageously, performing the above steps in real time upon occurrence of the event notifies user 141 about the event substantially immediately after the event's occurrence. The haptic nature of the alert also ensures user 141 will still be notified even if user 141 cannot see a screen of user system 101. Also, user 141 is not potentially distracted from their duties by an audible alert. Although, in some examples, other types of alerts corresponding to the event (e.g., a visually displayed alert) may be generated in addition to the haptic alert to ensure the haptic alert itself (or the meaning of the alert) does not go unnoticed.

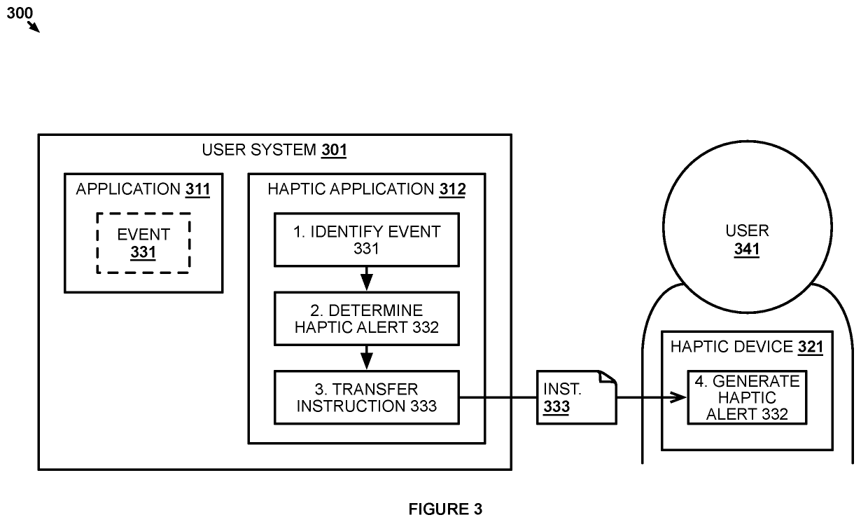

FIG. 3 illustrates operational scenario 300 that provides haptic alerts corresponding to contact center events. Operational scenario 300 involves user system 301 and haptic device 321. User system 301 is an example of user system 101 and haptic device 321 is an example of haptic device 121. User system 301 executes application 311 and haptic application 312. Though not shown, user system 301 may execute any number of other applications. In this example, application 311 is an application that user 341 uses to perform their duties in a contact center. For instance, application 311 may be an application that monitors agent metrics, may be a soft client for communication sessions with the contact center, may be a service ticket application, or some other type of application that a user may operate in a contact center environment. Haptic application 312 executes to identify events that occur in application 311 and/or other applications executing on user system 301. In some examples, user 341 may define which events haptic application 312 should detect while, in other examples, the event definitions may be received from outside of user system 301 (e.g., from a policy system or administrative user).

In operational scenario 300, haptic application 312 identifies the occurrence of event 331 in application 311 at step 1. Event 331 is one of the events that haptic application 312 is configured to detect, as mentioned above. Haptic application 312 may be notified by application 311 that event 331 has occurred, haptic application 312 may monitor network activity with application 311 to determine that event 331 has occurred, haptic application 312 may use an application programming interface (API) call to application 311 to obtain information indicating that event 331 has occurred, haptic application 312 may interact with a monitoring element of user system 301's operation system to identify that event 331 has occurred, or haptic application 312 may determine that event 331 has occurred in some other manner.

After identifying event 331, user system 301 directs user system 301 to determine that haptic alert 332 corresponds to event 331 at step 2. Haptic application 312 may be provided with information defining which haptic alerts correspond to which events at the same time, and from the same source, that haptic application 312 is provided with definitions of events to detect or haptic application 312 may be provided with that information at some other time and/or from some other source. For example, a policy system for the contact center may define events that should trigger alerts and user 341 may define the particular actuations (e.g., vibration pattern) that corresponds to each alert. Upon determining that haptic alert 332 should be presented to user 341, haptic application 312 directs user system 301 to transfer alert instruction 333 at step 3 to haptic device 321. Alert instruction 333 is transferred in any format readable by haptic device 321. Alert instruction 333 may be transferred using a wired and/or wireless communication protocol depending on the type of link between user system 301 and haptic device 321.

In response to receiving alert instruction 333 from user system 301, haptic device 321 generates haptic alert 332 at step 4 to notify user 341 that event 331 has occurred. To generate haptic alert 332, haptic device 321 activates (e.g., supplies power to) one or more actuators in haptic device 321 to produce the alert defined by haptic alert 332, which causes a haptic perception (e.g., vibration/pressure pattern sensation) for user 341. If alert instruction 333 does not define haptic alert 332 therein (e.g., merely provides a designation associated with haptic alert 332), then haptic device 321 may maintain its own data structure that defines the particular actuations that represent haptic alert 332. Regardless, after haptic device 321 generates haptic alert 332, user 341 has been notified in real time that event 331 occurred in application 311.

While haptic application 312 handles steps 1-3 in the above example, it should be understood that the functionality of haptic application 312 could be included in application 311 or an operating system of user system 301. For example, an API may be used to embed the functionality of haptic application 312 into application 311.

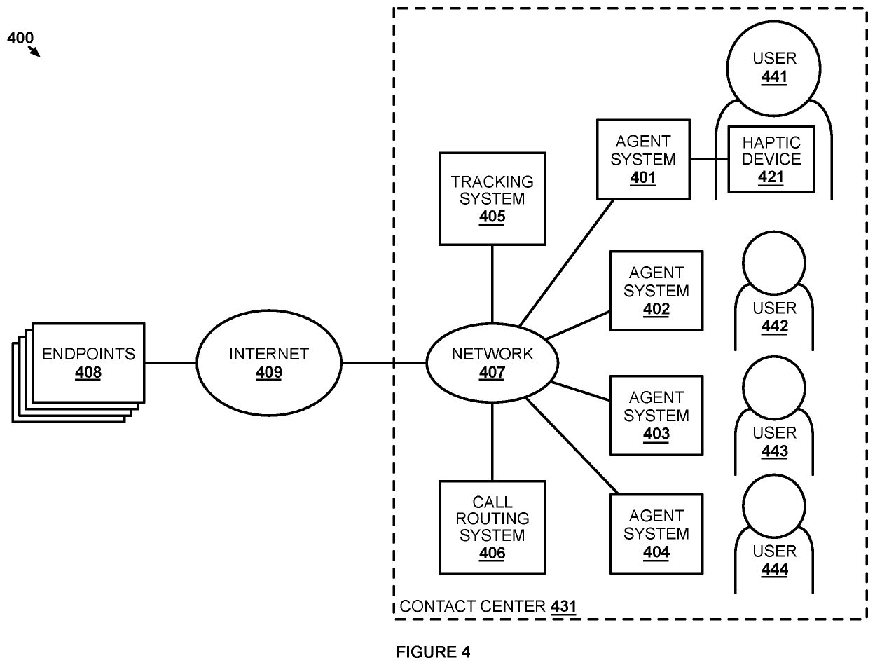

FIG. 4 illustrates implementation 400 for providing haptic alerts corresponding to contact center events. Implementation 400 includes agent systems 401-404, tracking system 405, call routing system 406, network 407, endpoints 408, and Internet 409. Users 441-444 operate respective agent systems 401-404 and are agents working in contact center 431 to handle communication sessions (e.g., voice, video, text chat, etc.) with users outside of contact center 431 that operate respective endpoints 408 (e.g., with customers of an entity operating contact center 431). Contact center 431 may be located in a single physical facility or may be distributed among multiple physical locations (e.g., multiple facilities, agent homes, etc.). As such, communication network 407 may be implemented, in part, over Internet 409 to connect multiple physical locations.

In operation, call routing system 406 determines which of users 441-445 should handle a call with contact center 431. The calls may be incoming or outgoing from contact center 431. While this example focuses on calls, it should be understood that agent systems 401-404 may be able to handle other kinds of communication sessions with contact center 431. When a user of users 441-444 is selected for a call, call routing system 406 routes the call to the associated agent system of agent systems 401-404 operated by the selected user (e.g., the selected user is logged into call routing system 406 using the associated agent system). Upon being routed the call, the associated agent system becomes an endpoint to the call. In this example, user 441 is a supervisor of users 442-444 and user 441 is able to perform their job using tracking system 405. Tracking system 405 tracks metrics for calls between agent systems 401-404 and callers at endpoints 408. The metrics may indicate call durations, call outcomes (e.g., issue resolved or not), call types (e.g., service, sales, etc.), customer survey responses, average hold times, number of abandoned calls (e.g., calls where the caller hangs up before reaching an agent), or some other type of information relevant to the operation of contact center 431. Through a client application or web-based dashboard on agent system 401, user 441 is able to view the metrics maintained by tracking system 405 and manage contact center 431 accordingly.

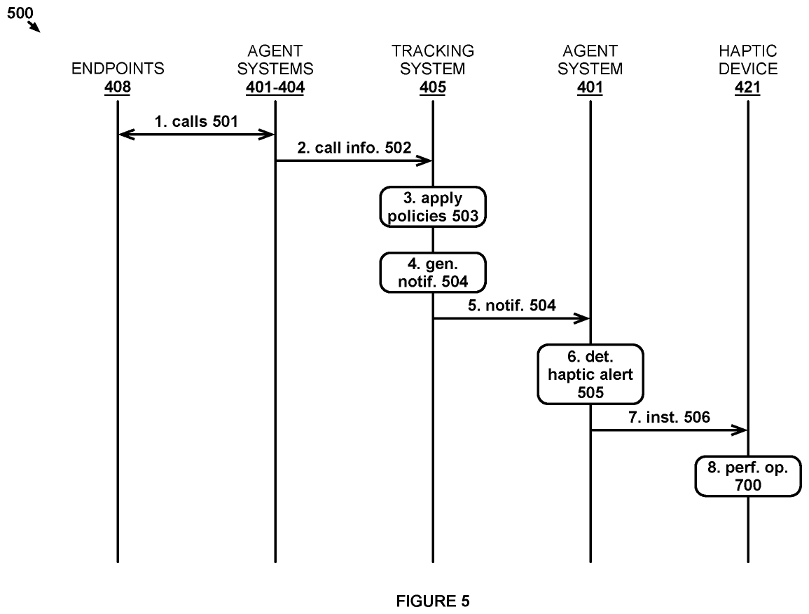

FIG. 5 illustrates an operational scenario 500 that provides haptic alerts corresponding to contact center events. In operational scenario 500, calls 501 are exchanged at step 1 between agent systems 401-404 and endpoints 408. In this example, even though user 441 is a supervisor, user 441 also handles calls with user 341. Tracking system 405 receives call information 502 at step 2 from agent systems 401-404 to maintain metrics about calls 501. Portions of call information 502 may be transferred to tracking system 405 during or after each of calls 501, periodically (e.g., once every hour), or on some other schedule. Call information 502 includes any information about calls 501 that is relevant to the metrics maintained by tracking system 405, such as a time and duration of each of calls 501, an outcome of each of calls 501, etc. In some examples, call information 502 may be received from other or additional systems, such as call routing system 406, which may report average wait times before reaching an agent.

As call information 502 is collected, tracking system 405 applies policies 503 at step 3 to metrics generated from call information 502. The metrics may include average/median call duration, average customer satisfaction rating, average/median queue wait time, or any other type of information that is relevant to the operation of contact center 431. Policies 503 include criteria that, when satisfied, trigger tracking system 405 to notify user 441. Policies 503 may be defined by a user, such as user 441, may be received from a policy system, or may be determined in some other manner. In an example, one of policies 503 may be a threshold amount of time for the average queue wait time metric. If the average queue wait time exceeds that threshold amount of time, then tracking system 405 notifies user 441. In another example, one of policies 503 may indicate a threshold rating for the average customer satisfaction rating and, when the average customer satisfaction rating drops below the threshold, tracking system 405 notifies user 441.

Upon satisfaction of one of policies 503, tracking system 405 generates notification 504 at step 4. Notification 504 indicates which of policies 503 was satisfied or otherwise indicates the reason for notification 504 being generated (e.g., customer satisfaction fell below a certain threshold). After generating notification 504, tracking system 405 transfers notification 504 to agent system 401 at step 5. Notification 504 may be transferred in any message format recognizable by agent system 401. In one example, agent system 401 may execute a metric tracking application that user 441 uses to view the metrics maintained by tracking system 405. In that case, notification 504 may be a message to that application. Similarly, while tracking system 405 applies policies 503 in this example to generate notification 504, in other examples, the metric tracking application on agent system 401 may instead apply policies 503 itself to generate notification 504.

After receiving notification 504, which would be the identified event in the examples above, agent system 401 determines that haptic alert 505 corresponds to notification 504 at step 6. Haptic alert 505 may be determined by a haptic alert application executing on agent system 401, by a metric tracking application executing on agent system 401, or in some other manner. As in the examples above, haptic alert 505 may be one of many different alerts that agent system 401 can determine depending on the corresponding notification or other event. Haptic alert 505 may be a generic alert for any notification received from tracking system 405 or may be specific to the type of notification that is notification 504 (e.g., may be specific to the policy that triggered generation of notification 504).

Once haptic alert 505 is determined, agent system 401 transfers instruction 506 at step 7 to haptic device 421. Instruction 506 may be transferred in any format, and using any protocol, that haptic device 421 is capable of receiving. Instruction 506 may simply identify haptic alert 505 to haptic device 421 and rely on haptic device 421 to recognize the particular actuations that represent haptic alert 505 or instruction 506 may define the actuations for haptic alert 505 to haptic device 421. In response to receiving instruction 506, haptic device 421 performs operation 700 at step 8, which is detailed below.

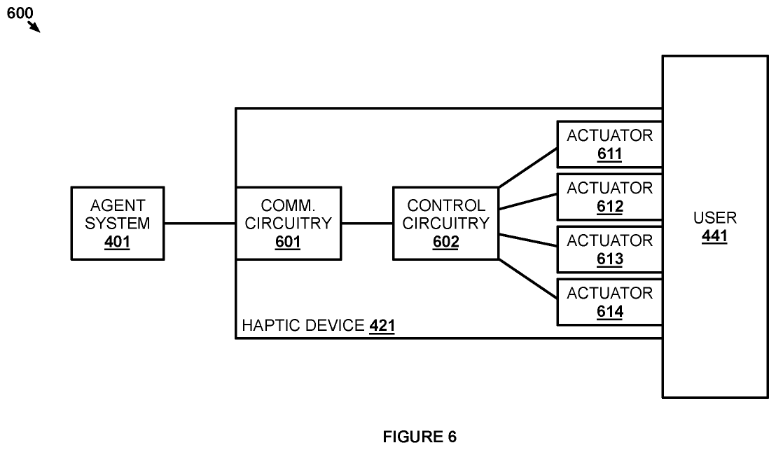

FIG. 6 illustrates implementation 600 for providing haptic alerts corresponding to contact center events. Implementation 600 focuses on agent system 401, haptic device 421, and user 441 from implementation 400. Haptic device 421 includes communication circuitry 601, control circuitry 602, and actuators 611-614. Actuators 611-614 may be motors, solenoids, or some other hardware component that can produce motion that user 441 can feel, such as vibrations, pressure applications, etc.—including combinations thereof. Other examples of haptic device 421 may include more or fewer actuators. Communication circuitry 601 implements a wired or wireless communication interface that enables a communication link between agent system 401 and haptic device 421. Control circuitry 602 enables processing of instructions received from agent system 401, such as instruction 506, to control activation of actuators 611-614 in accordance with those instructions. In some examples, control circuitry 602 may execute software to perform as described herein. To activate an actuator of actuators 611-614, control circuitry 602 either sends power to the actuator, which activate the actuator, or sends a control signal to the actuator, which draws power for actuation in response to the control signal. While actuators 611-614 are shown to be directly touching the portion of user 441 represented in implementation 600, it should be understood that there may be material between user 441 and actuators 611-614, such as housing material for haptic device 421 and clothing of user 441. Similarly, while actuators 611-614 are shown lined up next to each other, actuators 611-614 may be distributed elsewhere around user 441.

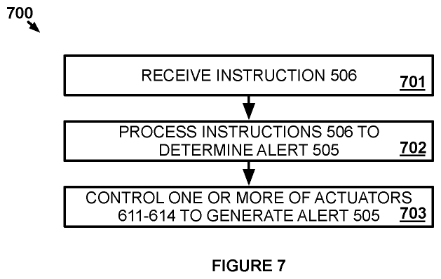

FIG. 7 illustrates operation 700 for providing haptic alerts corresponding to contact center events. In operation 700, control circuitry 602 of haptic device 421 receives instruction 506 from communication circuitry 601 (701). Communication circuitry 601 handled the receipt of instruction 506 from agent system 401 and any processing necessary to put instruction 506 in a format readable by control circuitry 602. For example, communication circuitry 601 may reconstruct instruction 506 based on the protocol used to transfer instruction 506 between agent system 401 and haptic device 421. Instruction 506 may be received from communication circuitry 601 over an internal system bus between communication circuitry 601 and control circuitry 602. In some examples, communication circuitry 601 and control circuitry 602 may be different components of the same circuitry (e.g., the same microchip).

Once instruction 506 is received from communication circuitry 601, control circuitry 602 processes instruction 506 to determine that haptic alert 505 should be generated (702). If, for example, instruction 506 explicitly defines how actuators 611-614 should be activated (e.g., in what pattern actuators 611-614 should be activated), then control circuitry 602's processing of haptic alert 505 may simply extract that definition. Alternatively, if instruction 506 simply identifies haptic alert 505, then control circuitry 602 may reference memory circuitry therein to determine the definition for how actuators 611-614 should be activated to generate haptic alert 505.

Regardless of how control circuitry 602 determines the definition of haptic alert 505, control circuitry 602 controls one or more of actuators 611-614 in accordance with the definition of haptic alert 505 (703). Controlling actuators 611-614 may include control circuitry 602 supplying, or triggering the supply of, power to appropriate ones of actuators 611-614. The power may be provided by a power supply of haptic device 421, from a wired link with agent system 401, or from some other source. Alternatively, control circuitry 602 may provide control signals to appropriate ones of actuators 611-614 that direct the actuators to activate. Regardless of how control circuitry 602 controls actuators 611-614 to activate, actuators 611-614 are activated to produce haptic alert 505. For example, if actuators 611-614 are vibration motors, the definition of haptic alert 505 may be two 0.25 second vibrations of actuator 611 followed by a 0.5 second vibration of actuator 614, with 0.25 seconds in between each of those three vibrations. Control circuitry 602 may then control actuator 611 to activate for 0.25 seconds, deactivate (e.g., stop the supply of power) for 0.25 seconds, and then activate for another 0.25 seconds before deactivating again. After waiting another 0.25 seconds following the second deactivation of actuator 611, control circuitry 602 controls actuator 614 to activate for 0.5 seconds before deactivating actuator 614. In another example, the definition of haptic alert 505 may be a vibration at one frequency followed by a vibration at a lower frequency, which is then followed by a vibration at a frequency in between the previous two. One or more of actuators 611-614 are controlled to produce the defined vibration frequencies in intervals also defined by haptic alert 505.

Assuming user 441 is aware of which haptic alerts correspond to which events (e.g., notifications), upon perception of the vibrations produced by actuators 611 and 614, user 441 will associate haptic alert 505 with the subject of notification 504 (e.g., will recognize that call queue wait times have risen above the threshold in policies 503). User 441 can then take action accordingly. In some examples, control circuitry 602 may continue to control actuators 611-614 to produce haptic alert 505 periodically (e.g., every two seconds) until receiving an instruction from agent system 401 to stop or agent system 401 will continue sending instruction 506 to haptic device 421 periodically until user 441 acknowledges that haptic alert 505 has occurred.

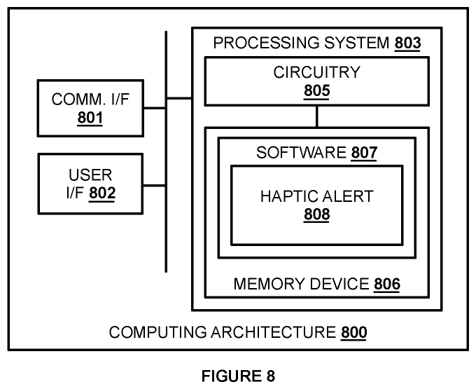

FIG. 8 illustrates computing architecture 800 for providing haptic alerts corresponding to contact center events. Computing architecture 800 is an example computing architecture for user system 101, user system 301, and agent systems 401-404, although systems 101, 301, and 401-404 may use alternative configurations. A similar architecture may also be used for other systems described herein (e.g., tracking system 405), although alternative configurations may also be used. Computing architecture 800 comprises communication interface 801, user interface 802, and processing system 803. Processing system 803 is linked to communication interface 801 and user interface 802. Processing system 803 includes processing circuitry 805 and memory device 806 that stores operating software 807.

Communication interface 801 comprises components that communicate over communication links, such as network cards, ports, RF transceivers, processing circuitry and software, or some other communication devices. Communication interface 801 may be configured to communicate over metallic, wireless, or optical links. Communication interface 801 may be configured to use TDM, IP, Ethernet, optical networking, wireless protocols, communication signaling, or some other communication format—including combinations thereof.

User interface 802 comprises components that interact with a user. User interface 802 may include a keyboard, display screen, mouse, touch pad, or some other user input/output apparatus. User interface 802 may be omitted in some examples.

Processing circuitry 805 comprises microprocessor and other circuitry that retrieves and executes operating software 807 from memory device 806. Memory device 806 comprises a computer readable storage medium, such as a disk drive, flash drive, data storage circuitry, or some other memory apparatus. In no examples would a storage medium of memory device 806 be considered a propagated signal. Operating software 807 comprises computer programs, firmware, or some other form of machine-readable processing instructions. Operating software 807 includes haptic alert module 808. Operating software 807 may further include an operating system, utilities, drivers, network interfaces, applications, or some other type of software. When executed by processing circuitry 805, operating software 807 directs processing system 803 to operate computing architecture 800 as described herein.

In particular, haptic alert module 808 directs processing system 803 to identify a first event at a user system operated by the user. The first event is associated with operation of a contact center staffed with a plurality of agents. Haptic alert module 808 further directs processing system 803 to determine that a first haptic alert corresponds to the first event and direct a haptic device in contact with the user's body to generate the first haptic alert for the user.

The descriptions and figures included herein depict specific implementations of the claimed invention(s). For the purpose of teaching inventive principles, some conventional aspects have been simplified or omitted. In addition, some variations from these implementations may be appreciated that fall within the scope of the invention. It may also be appreciated that the features described above can be combined in various ways to form multiple implementations. As a result, the invention is not limited to the specific implementations described above, but only by the claims and their equivalents.

1. A method for providing haptic alerts to a user, the method comprising:
identifying a first event at a user system operated by the user;
determining that a first haptic alert corresponds to the first event, wherein the first haptic alert is one of multiple different haptic alerts corresponding to different events associated with the operation of the contact center, and wherein the first haptic alert comprises a pressure pattern applied to one or more defined areas on the user's body; and
directing a haptic device in contact with the user's body to generate the first haptic alert for the user.

2. The method of claim 1, further comprising:
identifying a second event at the user system;
determining that a second haptic alert of the multiple different haptic alerts, which is different than the first haptic alert, corresponds to the second event; and
directing the haptic device to generate the second haptic alert for the user.

3. The method of claim 1, wherein the first haptic alert comprises a vibration pattern.

4. The method of claim 1, wherein the pressure pattern comprises a shape drawn on the user's body.

5. The method of claim 1, wherein directing the haptic device comprises:
transferring, to the haptic device, an instruction for the haptic device to generate the first haptic alert, wherein the haptic device includes circuitry that processes the instruction and controls one or more haptic actuators of the haptic device.

6. The method of claim 5, wherein the instruction is transferred over a wireless link between the user system and the haptic device, and wherein the haptic device includes a power supply to power the one or more actuators.

7. The method of claim 1, wherein determining that the first haptic alert corresponds to the first event comprises:
in the user system, executing a haptic-alert application that monitors for events from an application associated with the first event.

8. The method of claim 1, wherein the user is a supervisor of a the plurality of agents staffing a contact center and wherein the first event relates to a metric about performance of the plurality of agents.

9. The method of claim 1, wherein the haptic device is worn by the user.

10. The method of claim 1, wherein the user sits on the haptic device.

11. An apparatus for providing haptic alerts to a user, the apparatus comprising:
one or more computer readable storage media;
a processing system operatively coupled with the one or more computer readable storage media; and
program instructions stored on the one or more computer readable storage media that, when read and executed by the processing system, direct the processing system to:
identify a first event at a user system operated by the user;
determine that a first haptic alert corresponds to the first event, wherein the first haptic alert is one of multiple different haptic alerts corresponding to different events associated with the operation of the contact center, and wherein the first haptic alert comprises a pressure pattern applied to one or more defined areas on the user's body; and
direct a haptic device in contact with the user's body to generate the first haptic alert for the user.

12. The apparatus of claim 11, wherein the program instructions further direct the processing system to:
identify a second event at the user system;
determine that a second haptic alert of the multiple different haptic alerts, which is different than the first haptic alert, corresponds to the second event; and
direct the haptic device to generate the second haptic alert for the user.

13. The apparatus of claim 11, wherein the first haptic alert comprises a vibration pattern.

14. The apparatus of claim 11, wherein the pressure pattern comprises a shape drawn on the user's body.

15. The apparatus of claim 11, wherein to direct the haptic device, the program instructions direct the processing system to:
transfer, to the haptic device, an instruction for the haptic device to generate the first haptic alert, wherein the haptic device includes circuitry that processes the instruction and controls one or more haptic actuators of the haptic device.

16. The apparatus of claim 15, wherein the instruction is transferred over a wireless link between the user system and the haptic device, and wherein the haptic device includes a power supply to power the one or more actuators.

17. The apparatus of claim 11, wherein to determine that the first haptic alert corresponds to the first event, the program instructions direct the processing system to:
execute a haptic-alert application that monitors for events from an application associated with the first event.

18. The apparatus of claim 11, wherein the user is a supervisor of a plurality of agents staffing a contact center and wherein the first event relates to a metric about performance of the plurality of agents.

19. The apparatus of claim 11, wherein the haptic device is either worn by or sat on by the user.

20. One or more computer readable storage media having program instructions stored thereon for providing haptic alerts to a user, the program instructions, when read and executed by a processing system, direct the processing system to:
identify a first event at a user system operated by the user;
determine that a first haptic alert corresponds to the first event, wherein the first haptic alert is one of multiple different haptic alerts corresponding to different events associated with the operation of the contact center, and wherein the first haptic alert comprises a pressure pattern applied to one or more defined areas on the user's body; and
direct a haptic device in contact with the user's body to generate the first haptic alert for the user.
